(19) United States
(12) Patent Application Publication
(10) Pub. No.: US 2026/0332238 A1
(43) Pub. Date: Oct. 22, 2026

(54) RECONFIGURABLE TRUE TIME-DELAY UNIT INTEGRATED CIRCUIT WITH SWITCHABLE EQUALIZERS AND ATTENUATORS FOR LOW ERROR BROADBAND OPERATION

(71) Applicant: Qorvo US, Inc., Greensboro, NC (US)

(72) Inventors: Kurt Cimino, Richardson, TX (US); Charles Forrest Campbell, Dallas, TX (US)

(21) Appl. No.: 19/458,109

(22) Filed: Jan. 23, 2026

Related U.S. Application Data
(60) Provisional application No. 63/761,220, filed on Feb. 21, 2025.
(60) Provisional application No. 63/869,737, filed on Aug. 25, 2025.

(51) Int. Cl. H04B 7/08; H04B 7/005

(52) U.S. Cl. CPC H04B 7/0894; H04B 7/005; H04B 7/0828

(57) ABSTRACT

The present disclosure relates to a reconfigurable True Time-Delay Unit (TDU) integrated circuit with switchable equalizers and attenuators for low operation error over multiple frequency bands. The reconfigurable TDU includes a first signal path and a second signal path, each extending between an input port and an output port, and corresponding to different delay states. The reconfigurable TDU also includes at least one attenuator and at least one equalizer. Based on operation in different frequency bands, the at least one attenuator is selectively switched into or out of the first signal path, while the at least one equalizer is selectively connected to or disconnected from the second signal path. Both insertion loss added to the first signal path by the at least one attenuator and equalization applied to the second signal path by the at least one equalizer are different for each one of the multiple frequency bands.

### RELATED APPLICATIONS

This application claims the benefit of provisional patent application Ser. No. 63/761,220, filed Feb. 21, 2025, and provisional patent application Ser. No. 63/869,737, filed Aug. 25, 2025, the disclosures of which are hereby incorporated herein by reference in their entireties.

### FIELD OF THE DISCLOSURE

The present disclosure relates to a reconfigurable True Time-Delay Unit (TDU) integrated circuit with switchable equalizers and attenuators for low error broadband operation.

### BACKGROUND

Broadband beamforming is a key technique used in advanced antenna arrays for wireless communication, radar, and electronic warfare systems. Unlike narrowband beamforming, which relies on phase shifts to steer the beam, broadband systems typically utilize time delays to preserve signal fidelity across a wide frequency range. To implement these time delays, each antenna element might be equipped with a True Time-Delay Unit (TDU) integrated circuit that switches between delay states, each with a different amount of time delay.

Two critical performance metrics for the TDU integrated circuit are time delay error and magnitude error. Time delay error refers to the deviation between the actual delay and the desired delay, which indicates how precisely the TDU integrated circuit presents the desired amount of time delay and directly affects the beam pointing accuracy. Magnitude error, on the other hand, refers to the variation in insertion loss across different delay states, relative to the zero-delay or reference state. In other words, magnitude error is how much additional loss is added to the system with delay added compared to the loss with no delay added. High magnitude error can lead to amplitude distortion in the beamformed signal, impacting overall system performance.

Minimizing both time delay error and magnitude error is critical for achieving high performance in broadband beamforming. Low time delay error ensures precise beam steering, while minimal magnitude error maintains consistent signal amplitude across different delay states. Therefore, there is a clear need for a True Time-Delay Unit (TDU) integrated circuit that delivers accurate and reliable time delays without introducing significant variations in signal loss.

### SUMMARY

The present disclosure relates to a reconfigurable True Time-Delay Unit (TDU) integrated circuit with switchable equalizers and attenuators for low operation error over multiple frequency bands. The disclosed reconfigurable TDU includes a first signal path and a second signal path, each extending between an input port and an output port and corresponding to different delay states. The reconfigurable TDU also includes at least one attenuator and at least one equalizer. Based on operation in different ones of the multiple frequency bands, the at least one attenuator is selectively switched into or out of the first signal path, while the at least one equalizer is selectively connected to or disconnected from the second signal path. For each one of the multiple frequency bands, both insertion loss introduced into the first signal path by the at least one attenuator and an amount of equalization applied to the second signal path by the at least one equalizer are different.

In one embodiment of the reconfigurable TDU, the different delay states achieved in the first signal path and the second signal path are implemented using transmission lines.

In one embodiment of the reconfigurable TDU, the different delay states achieved in the first signal path and the second signal path are implemented using inductors, capacitors, or combinations thereof.

In one embodiment of the reconfigurable TDU, a total length of the transmission lines used in the second signal path is greater than a total length of the transmission lines used in the first signal path.

According to one embodiment, the reconfigurable TDU further includes an input switch and an output switch configured to select between the first signal path and the second signal path from the input port to the output port.

In one embodiment of the reconfigurable TDU, the at least one attenuator is implemented by one or more resistors.

In one embodiment of the reconfigurable TDU, the at least one attenuator includes a number of attenuators, and each of the attenuators introduces a different amount of insertion loss to the first signal path.

In one embodiment of the reconfigurable TDU, the at least one attenuator includes a number of attenuators. Herein, each of the attenuators introduces a same amount of insertion loss to the first signal path. For each one of the multiple frequency bands, a different number of the attenuators are switched into the first signal path.

In one embodiment of the reconfigurable TDU, the at least one equalizer is implemented by a resistor and an inductor connected in series and coupled between a certain point of the second signal path and ground.

In one embodiment of the reconfigurable TDU, the at least one equalizer includes a number of equalizers, and each of the equalizers introduces a different equalization amount to the second signal path.

In one embodiment of the reconfigurable TDU, the at least one equalizer includes a number of equalizers. Herein, each of the equalizers introduces a same equalization amount to the second signal path. For each one of the multiple frequency bands, a different number of equalizers are switched into the second signal path.

In one embodiment of the reconfigurable TDU, the at least one attenuator includes a number of attenuators, and the at least one equalizer includes a number of equalizers. Herein, a certain one or more of the attenuators and/or a certain one or more of the equalizers are reused across the multiple frequency bands.

In one embodiment of the reconfigurable TDU, the at least one attenuator includes a number of attenuators, and the at least one equalizer includes a number of equalizers. For a specific one of the multiple frequency bands, the number of attenuators used for the first signal path is equal to the number of equalizers used for the second signal path.

In one embodiment of the reconfigurable TDU, the at least one attenuator includes a number of attenuators, and the at least one equalizer includes a number of equalizers. Each of the attenuators and each of the equalizers is used for a specific one of the multiple frequency bands.

In one embodiment of the reconfigurable TDU, for a specific one of the multiple frequency bands, none of the at least one attenuator is switched into the first signal path, and none of the at least one equalizer is connected to the second signal path.

In one embodiment of the reconfigurable TDU, the number of the at least one attenuator and the number of the at least one equalizer are the same.

In one embodiment of the reconfigurable TDU, the number of the at least one attenuator and the number of the at least one equalizer are different.

According to one embodiment, the reconfigurable TDU further includes one or more first switches configured to selectively switch the at least one attenuator into or switch the at least one attenuator out of the first signal path, and one or more second switches configured to selectively connect the at least one equalizer to or disconnect the at least one equalizer from the second signal path.

According to one embodiment, a communication device includes receive circuitry, transmit circuitry, and antenna switching circuitry, which is configured to transmit radio frequency signals between antennas and the receive circuitry and/or between the antennas and the transmit circuitry. Herein, at least one reconfigurable TDU, which includes a first signal path, a second signal path, at least one attenuator, and at least one equalizer, is included in at least one of the transmit circuitry and the receive circuitry. Each of the first signal path and the second signal path extends between an input port and an output port, and the first signal path and the second signal path correspond to different delay states. Based on operation in different ones of multiple frequency bands, the at least one attenuator is selectively switched into or out of the first signal path, while the at least one equalizer is selectively connected to or disconnected from the second signal path. Both insertion loss added to the first signal path by the at least one attenuator and equalization applied to the second signal path by the at least one equalizer are different for each one of the multiple frequency bands.

In another aspect, any of the foregoing aspects individually or together, and/or various separate aspects and features as described herein, may be combined for additional advantage. Any of the various features and elements as disclosed herein may be combined with one or more other disclosed features and elements unless indicated to the contrary herein.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 shows a typical True Time-Delay Unit (TDU), which employs switches and transmission lines to realize different delay states.

FIG. 2 illustrates insertion loss associated with the different delay states achieved by the typical TDU shown in FIG. 1.

FIG. 3 shows the TDU with additional insertion loss and frequency equalization.

FIG. 4 illustrates insertion loss associated with the different delay states achieved by the TDU shown in FIG. 3.

FIGS. 5A and 5B show an exemplary reconfigurable TDU with a switchable attenuator and a switchable equalizer according to embodiments of the present disclosure.

FIG. 6 illustrates insertion loss associated with the different delay states achieved by the reconfigurable TDU shown in FIGS. 5A and 5B.

FIG. 7 shows the reconfigurable TDU with multiple switchable attenuators and multiple switchable equalizers according to embodiments of the present disclosure.

FIG. 8 illustrates insertion loss associated with the different delay states achieved by the reconfigurable TDU shown in FIG. 7.

FIG. 9 is a block diagram of a communication device, which includes at least one reconfigurable TDU according to some embodiments of the present disclosure.

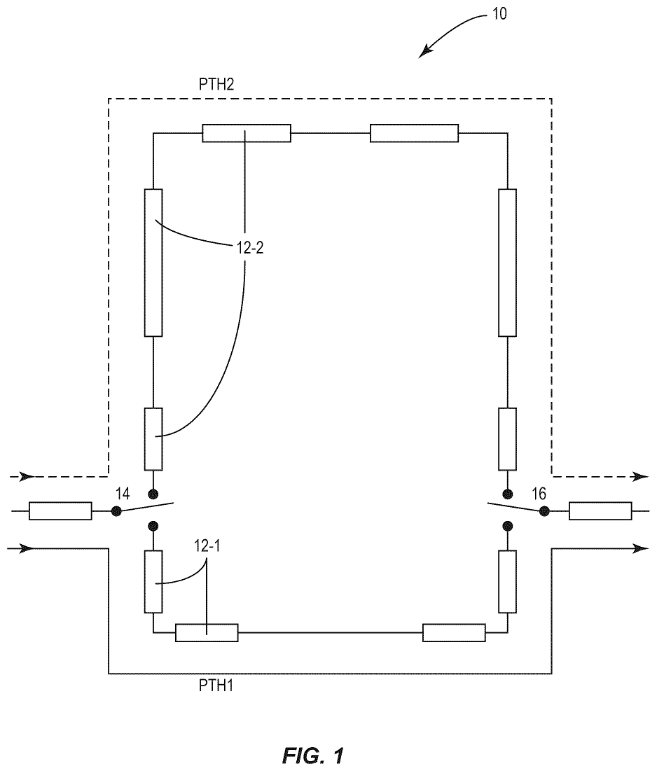

It will be understood that for clarity of illustration, FIGS. 1-9 may not be drawn to scale.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments are described herein with reference to schematic illustrations of embodiments of the disclosure. As such, the actual dimensions of the layers and elements can be different, and variations from the shapes of the illustrations as a result, for example, of manufacturing techniques and/or tolerances, are expected. For example, a region illustrated or described as square or rectangular can have rounded or curved features, and regions shown as straight lines may have some irregularity. Thus, the regions illustrated in the figures are schematic and their shapes are not intended to illustrate the precise shape of a region of a device and are not intended to limit the scope of the disclosure. Additionally, sizes of structures or regions may be exaggerated relative to other structures or regions for illustrative purposes and, thus, are provided to illustrate the general structures of the present subject matter and may or may not be drawn to scale. Common elements between figures may be shown herein with common element numbers and may not be subsequently re-described.

Broadband beamforming is desired to operate over wide frequency ranges to support diverse applications such as radar, satellite communications, and advanced wireless systems. These frequency ranges can extend from below the S-band (i.e., frequencies under 2 GHz) to as high as the K-band (up to 28 GHz and beyond). Operating across such a broad spectrum imposes stringent requirements on the underlying hardware, particularly True Time-Delay Unit (TDU) integrated circuits, which are desired to maintain consistent performance (including accurate time delays and minimal signal loss) over the entire frequency range.

To achieve low time-delay errors across broad bandwidths, TDU integrated circuits (herein and hereafter, “TDU” and “TDU integrated circuit” may be used interchangeably) often utilize transmission lines, which can provide a nearly flat time delay over frequency. FIG. 1 illustrates a typical TDU 10 including two signal paths PTH, each corresponding to a different delay state (e.g., a first signal path PTH1 realizing a reference or no-delay state, and a second signal path PTH2 realizing a delay state). For the purpose of this illustration, the first signal path PTH1 is implemented using four relatively short first transmission lines 12-1, while the second signal path PTH2 is implemented using six relatively long second transmission lines 12-2 (only certain transmission lines are labeled with reference numbers for clarity). In different applications, each signal path PTH may utilize a different number of transmission lines 12, as long as the first and second signal paths PTH1 and PTH2 produce distinct delay states.

The TDU 10 is configured to route a signal through either the first signal path PTH1 or the second signal path PTH2 by selectively activating the corresponding path, thereby enabling delay control of the signal. An input switch 14 and an output switch 16 are also included in the TDU 10 to perform this selection between the reference and delay states (e.g., both the input switch 14 and the output switch 16 are connected to the first/bottom signal path to achieve the reference state, while both the input switch 14 and the output switch 16 are connected to the second/top signal path to achieve the delay state).

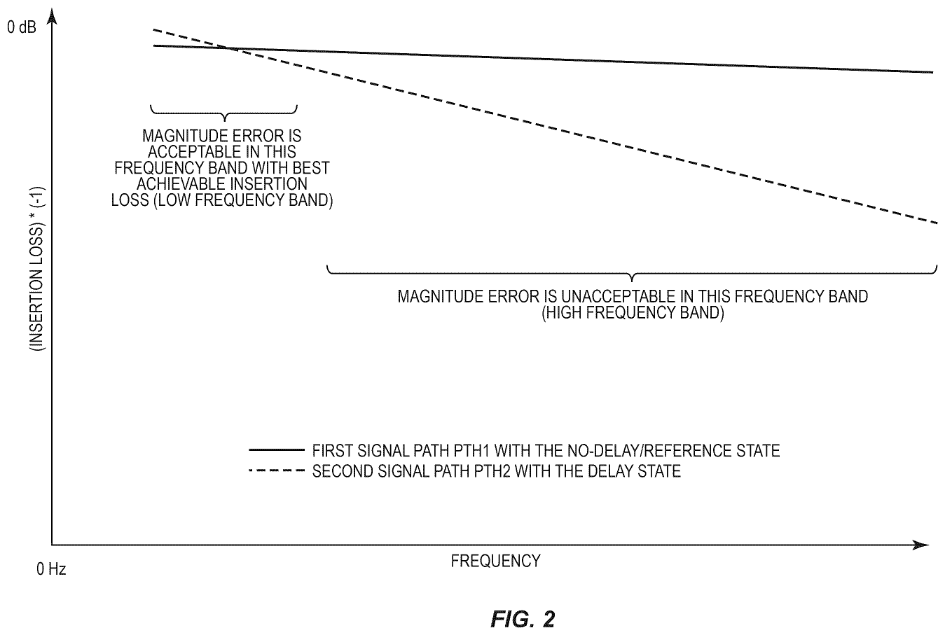

Insertion loss associated with the reference and delay states, which are selected by the input and output switches 14 and 16, is shown in FIG. 2. It is clear to note that the insertion loss of the first signal path, corresponding to the reference state, exhibits a shallow slope across frequency (e.g., represented by a solid line), whereas the insertion loss of the second signal path, corresponding to the delay state, exhibits a steeper slope across frequency (e.g., represented by a dashed line). The underlying cause of this phenomenon is the different total lengths of transmission lines 12 in the first and second signal paths PTH1 and PTH2, which results in different frequency-dependent insertion loss. As a result, achieving a low magnitude error (defined as an acceptable/small difference in insertion loss between the reference and delay states) becomes possible only within a limited portion of overall bandwidth (e.g., within a low-frequency band), even though time-delay error may remain consistently low across a much wider range. Consequently, this phenomenon inherently limits the usable bandwidth of the TDU 10. For this illustration, at lower frequencies, the difference in insertion loss (i.e., magnitude error) between the reference and delay states is minimal and within acceptable limits. However, at higher frequencies, the difference in insertion loss (i.e., magnitude error) between the reference and delay states becomes significant and exceeds acceptable thresholds, rendering the TDU 10 unsuitable for operation in those frequency ranges.

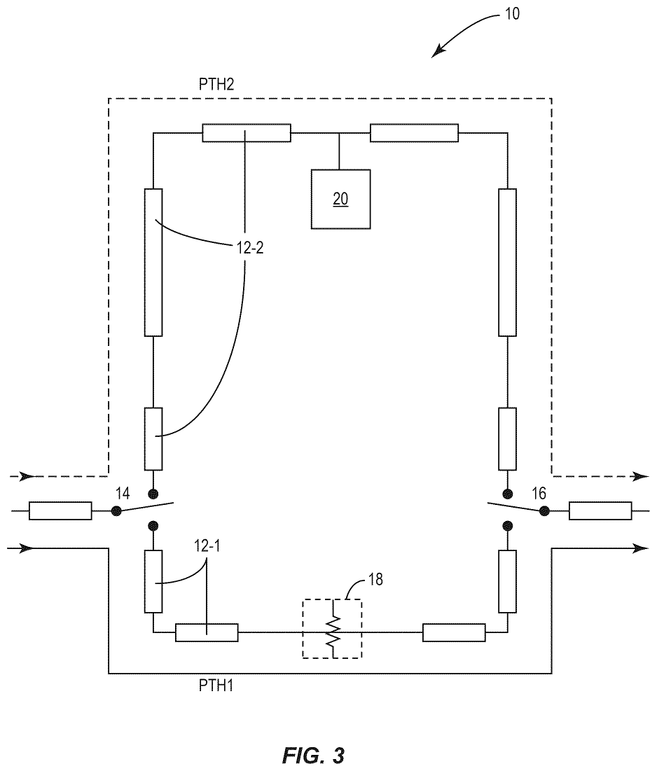

To reduce overall magnitude error and thereby expand the operational frequency range, the second signal path PTH2, corresponding to the delay state, may be designed to incorporate frequency equalization to flatten its insertion loss response across the frequency spectrum. As such, the slope difference between the insertion loss of the second signal path PTH2 and the insertion loss of the first signal path PTH1 is reduced. Typically, the addition of frequency equalization introduces extra insertion loss. Therefore, the first signal path PTH1, corresponding to the reference state, may be designed to include additional insertion loss to match that of the second signal path PTH2. As illustrated in FIG. 3, the TDU 10 further includes an attenuator 18 coupled in series with the first transmission lines 12-1 within the first signal path PTH1, and an equalizer 20 connected to a center point of the second signal path PTH2.

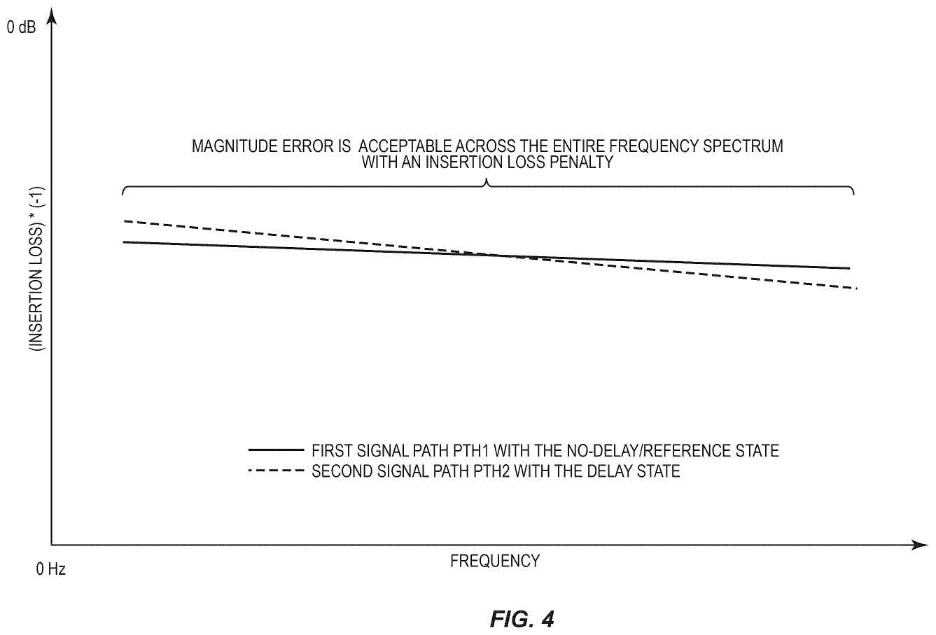

FIG. 4 illustrates insertion loss associated with the different delay states achieved by the TDU 10 shown in FIG. 3. The addition of the attenuator 18 and the equalizer 20 may help achieve an acceptable magnitude error between the first and second signal paths PTH1 and PTH2. However, incorporating the attenuator 18 and the equalizer 20 results in increased insertion loss across the entire frequency spectrum. This is undesirable, as it necessitates extra gain to be added to the system regardless of the frequency band of operation.

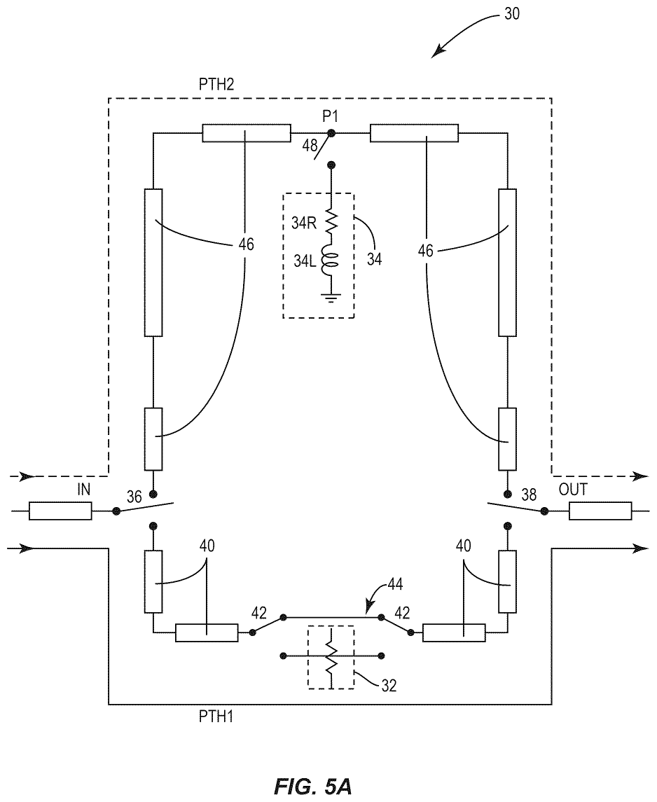

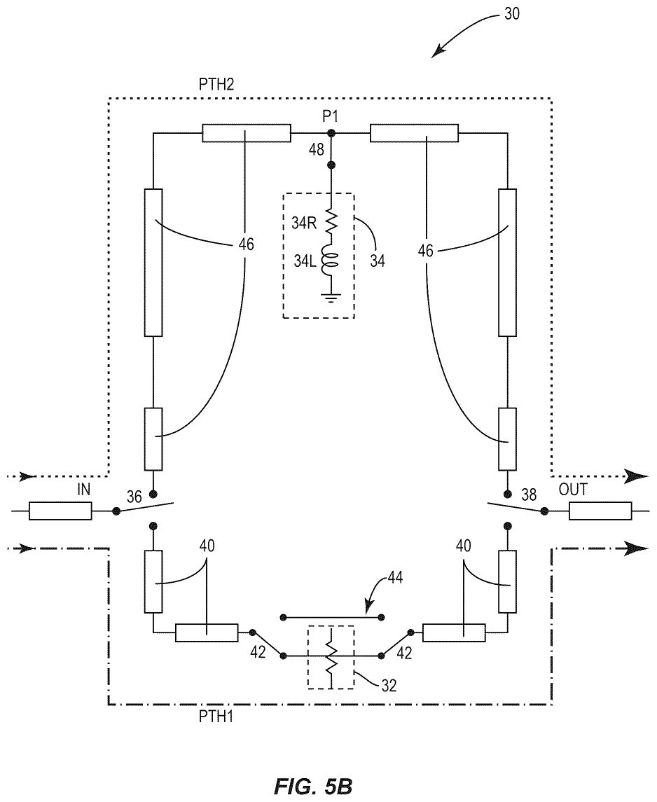

FIGS. 5A and 5B illustrate an exemplary reconfigurable TDU 30 with a switchable attenuator 32 and a switchable equalizer 34 for low error broadband operation. Similar to the TDU 10, the reconfigurable TDU 30 also includes a first signal path (a bottom path) PTH1 and a second signal path (a top path) PTH2, each of which extends between an input port IN and an output port OUT, and an input switch 36 and an output switch 38 configured to perform selection between the first signal path PTH1 and the second signal path PTH2. For the purpose of this illustration, the first signal path PTH1 includes four relatively short first transmission lines 40 configured to realize a reference state and two PTH1 switches 42 configured to selectively switch the attenuator 32 or a low-attenuation element 44 (e.g., a conducting line) into the first signal path PTH1. The second signal path PTH2 includes six relatively long second transmission lines 46 configured to realize a delay state. The reconfigurable TDU 30 further includes a PTH2 switch 48 configured to connect/disconnect the equalizer 34 to/from a certain point P1 of the second signal path PTH2 (e.g., at a center point of the second signal path PTH2, where the second transmission lines 46 before and after the center point are symmetric, or at any arbitrary location along the second signal path PTH2, where the second transmission lines 46 before and after such location are asymmetric, not shown). The attenuator 32 may be implemented by one or more resistors, while the equalizer 34 may be implemented as a shunt R-L structure (e.g., a resistor 34R and an inductor 34L connected in series and coupled to ground).

In different applications, each signal path PTH may utilize a different number of transmission lines, as long as a total length of the second transmission lines 46 within the second signal path PTH2 is greater than a total length of the first transmission lines 40 within the first signal path PTH1, so as to produce a different delay state relative to the reference state produced by the first signal path PTH1. Additionally, the transmission lines 40/46 within each signal path PTH may be replaced by other suitable circuit elements to achieve time delaying, such as inductors, capacitors, or combinations thereof, provided that the first and second signal paths PTH1 and PTH2 generate distinct delay states. Furthermore, the attenuator 32 and the equalizer 34 may be implemented in various forms (e.g., a shunt R-L for equalization merely for illustrative purposes and not by way of limitation), as long as any delay errors introduced into the first and second signal paths PTH1 and PTH2 by the attenuator 32 and the equalizer 34 are negligible or can effectively cancel each other out. As such, the time delay difference between the first and second signal paths PTH1 and PTH2 can be constantly maintained. The attenuator 32 or the low-attenuation element 44 may be selectively switched into any position of the first signal path PTH1 and coupled in series with the first transmission lines 40. The equalizer 34 may be coupled to any point of the second signal path PTH2.

By enabling the attenuator 32 and the equalizer 34—integrated within the reconfigurable TDU 30—to be selectively switched into and out of the first and second signal paths PTH1 and PTH2, the reconfigurable TDU 30 can operate across broadband frequencies without being subject to unnecessary insertion loss penalties in certain frequency ranges that inherently exhibit acceptable magnitude error (e.g., within a low frequency band). Herein, the attenuator 32 and the equalizer 34 can be switched into or out of the signal paths PTH1/PTH2 as needed, enabling operation in a desired band with an optimal trade-off among the delay error, insertion loss, and magnitude error.

For a non-limiting example, as shown in FIG. 5A, for low frequency band operation, the two PTH1 switches 42 selectively switch the low-attenuation element 44 into the first signal path PTH1, while the PTH2 switch 48 is open to disconnect the equalizer 34 from the second signal path PTH2. For high frequency band operation, as shown in FIG. 5B, the two PTH1 switches 42 selectively switch the attenuator 32 into the first signal path PTH1, while the PTH2 switch 48 is closed to connect the equalizer 34 to the certain point P1 of the second signal path PTH2.

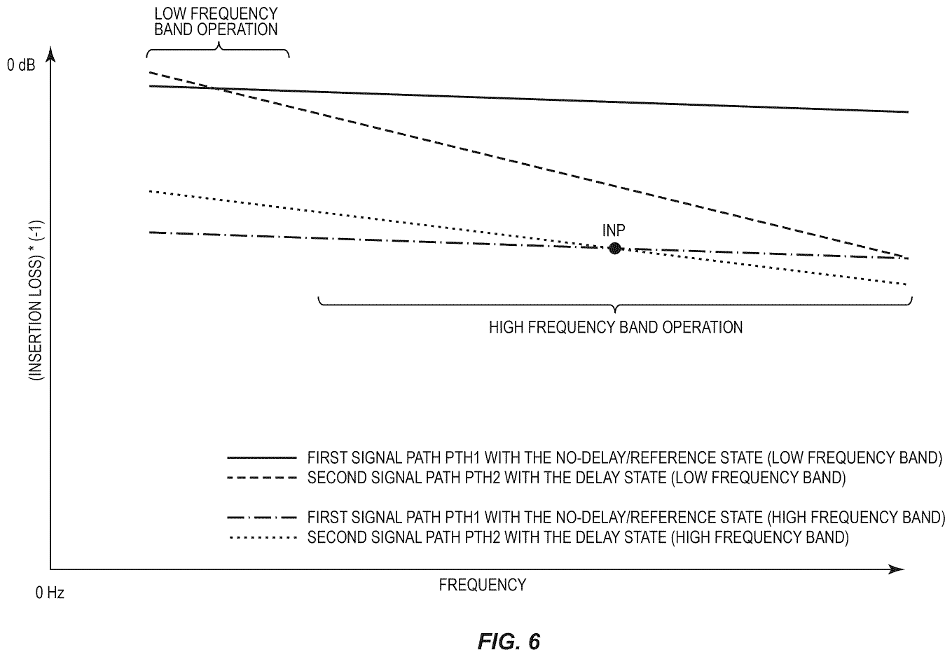

FIG. 6 illustrates insertion loss associated with the different delay states achieved by the reconfigurable TDU 30 shown in FIGS. 5A and 5B. Within the low-frequency band, the reconfigurable TDU 30 operates similarly to the TDU 10 shown in FIG. 1, where the magnitude error between the first signal path PTH1 (the reference state) and the second signal path PTH2 (the delay state) are within acceptable limits, while the insertion loss of the first and second signal paths PTH1 and PTH2 is minimized to the best achievable level. Within the high-frequency band, the reconfigurable TDU 30 operates similarly to the TDU 10 employing the fixed attenuator 18 and the equalizer 20 shown in FIG. 3, where the insertion loss of the first and second signal paths PTH1 and PTH2 is sacrificed to keep the magnitude error between the first signal path PTH1 (the reference state) and the second signal path PTH2 (the delay state) within acceptable limits.

Herein, the equalizer 34 and the attenuator 32 are designed, such that the slope difference between the insertion loss trajectories of the first and second signal paths PTH1 and PTH2 does not exceed a certain ratio (e.g., <=15%). Additionally, to achieve minimal overall magnitude error within the high-frequency band, if both the insertion loss trajectories of the first and second signal paths PTH1 and PTH2 increase linearly and monotonically, it is desirable for an intersection point INP of the insertion loss trajectories of the first and second signal paths PTH1 and PTH2 to be located at a center frequency of the high-frequency band. Note that, although the insertion loss of the first and second signal paths PTH1 and PTH2 still increases to keep the magnitude error within the acceptable limits across the high-frequency band, the overall insertion loss of the first and second signal paths PTH1 and PTH2 across the entire frequency spectrum is significantly reduced when compared to the TDU 10 employing the fixed attenuator 18 and the equalizer 20. This improvement is attributed to the low insertion loss within the low-frequency band.

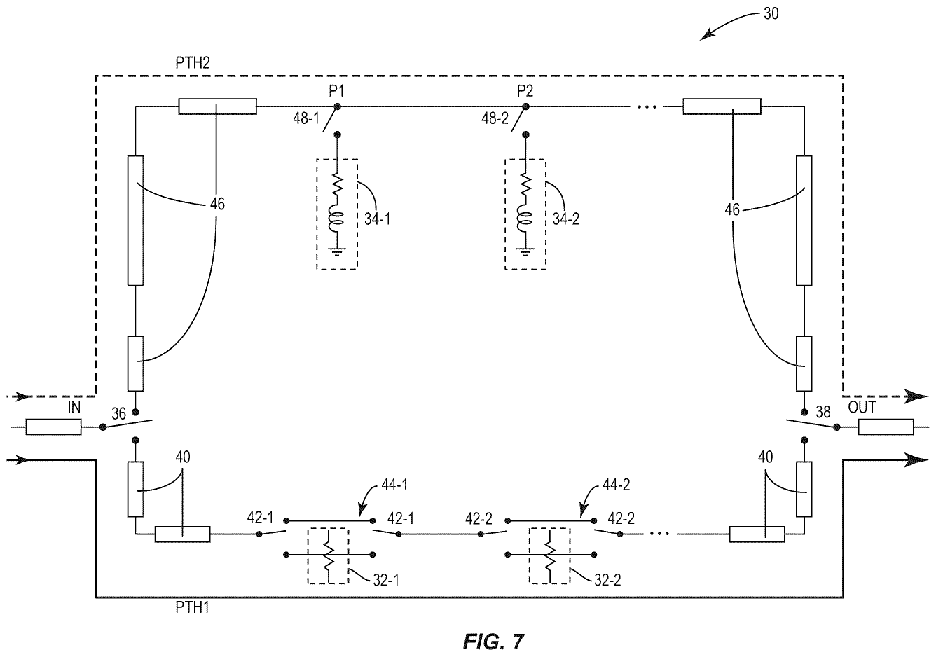

In some applications, the entire frequency spectrum may be divided into multiple operating bands. Accordingly, the reconfigurable TDU 30 can be extended to include as many switchable attenuators and equalizers as necessary to achieve the optimal tradeoff among the insertion loss, delay error, and magnitude error. FIG. 7 shows the reconfigurable TDU 30 operating over multiple (e.g. no less than three) frequency bands.

In detail, the reconfigurable TDU 30 includes multiple attenuators 32 (e.g., a first attenuator 32-1, a second attenuator 32-2, etc.), multiple low-attenuation elements 44 (e.g., a first low-attenuation element 44-1, a second low-attenuation element 44-2, etc.), and multiple PTH1 switches 42 (e.g., a pair of first PTH1 switches 42-1, a pair of second PTH1 switches 42-2, etc.) that are configured to selectively switch certain ones of the attenuators 32 and the low-attenuation elements 44 into the first signal path PTH1. In addition, the reconfigurable TDU 30 also includes multiple equalizers 34 (e.g., a first equalizer 34-1, a second equalizer 34-2, etc.) and multiple PTH2 switches 48 (e.g., a first PTH2 switch 48-1, a second PTH2 switch 48-2, etc.) that are configured to connect/disconnect the corresponding equalizers 34 to/from the second signal path PTH2.

Each attenuator 32 may be implemented using the same or a different configuration. As a non-limiting example, one attenuator 32 may be implemented by one or more resistors. Each attenuator 32 may introduce the same or a different amount of insertion loss to the first signal path PTH1 depending on the specific application. Similarly, each equalizer 34 may be implemented using the same or a different configuration. As a non-limiting example, one equalizer 34 may be implemented using a shunt R-L structure. The resistance and inductance values of the shunt R-L structure may vary or remain the same for each equalizer 34, depending on the application, such that each equalizer 34 may introduce the same or a different equalization amount to the second signal path PTH2. Any delay errors introduced into the first and second signal paths PTH1 and PTH2 by the attenuators 32 and the equalizers 34 should be negligible or can effectively cancel each other out. As such, the time delay difference between the first and second signal paths PTH1 and PTH2 can be constantly maintained.

By enabling the attenuators 32 and the equalizers 34—integrated within the reconfigurable TDU 30—to be selectively switched into and out of the first and second signal paths PTH1 and PTH2, the reconfigurable TDU 30 can operate across multiple frequency bands with an optimal trade-off among the delay error, insertion loss, and magnitude error. In different applications, to operate within a specific frequency band, none, one, or multiple attenuators 32 may be switched into the first signal path PTH1, and none, one, or multiple equalizers 34 may be connected to the second signal path PTH2 through the corresponding PTH2 switches 48. If each attenuator 32 introduces the same amount of insertion loss to the first signal path PTH1, for each specific frequency band, a different number of the attenuators 32 is switched into the first signal path PTH1 to add a different overall insertion loss. Similarly, if each equalizer 34 introduces the same equalization amount to the second signal path PTH2, for each specific frequency band, a different number of the equalizers 34 is connected to the second signal path PTH2 to achieve a different overall equalization amount. Additionally, the number of attenuators 32 and the number of equalizers 34 utilized for a specific frequency band may be the same or different.

For different frequency bands, both the attenuation applied to the first signal path PTH1 and the equalization applied to the second signal path PTH2 are different. For a non-limiting example, for Band #0 operation, the PTH1 switches 42 connect each low-attenuation element 44 into the first signal path PTH1, while each PTH2 switch 48 is open to disconnect a corresponding equalizer 34 from the second signal path PTH2. For Band #1 operation, the first PTH1 switches 42-1 selectively switch the first attenuator 32-1 into the first signal path PTH1, while the remaining PTH1 switches 42 (e.g., the second PTH1 switches 42) selectively switch the corresponding low-attenuation element(s) 44 (e.g., the second low-attenuation element 44-2) into the first signal path PTH1. In addition, the first PTH2 switch 48-1 is closed to connect the first equalizer 34-1 to the second signal path PTH2, while the remaining PTH2 switch(es) 48 (e.g., the second PTH2 switch 48-2) remain open. For Band #2 operation, the second PTH1 switches 42-2 selectively switch the second attenuator 32-2 into the first signal path PTH1, while the remaining PTH1 switches 42 (e.g., the first PTH1 switches 42-1), depending on the amount of attenuation required, selectively switch the corresponding low-attenuation element(s) 44 (e.g., the first low-attenuation element 44-1) or the corresponding high-attenuation element(s) 32 (e.g., the first high-attenuation element 32-1) into the first signal path PTH1. In addition, the second PTH2 switch 48-2 is closed to connect the second equalizer 34-2 to the second signal path PTH2, while the remaining PTH2 switch(es) 48 (e.g., the first PTH2 switch 48-1), depending on the amount of equalization required, remain open or are also closed to connect the corresponding equalizer(s) 34 (e.g., the first equalizer 34-1) to the second signal path PTH2. In general, any combination of the high-attenuation elements 32 and/or the equalizers 34 may be switched into or out of the corresponding first and second signal paths PTH1 and PTH2, respectively, to achieve the attenuation and equalization required.

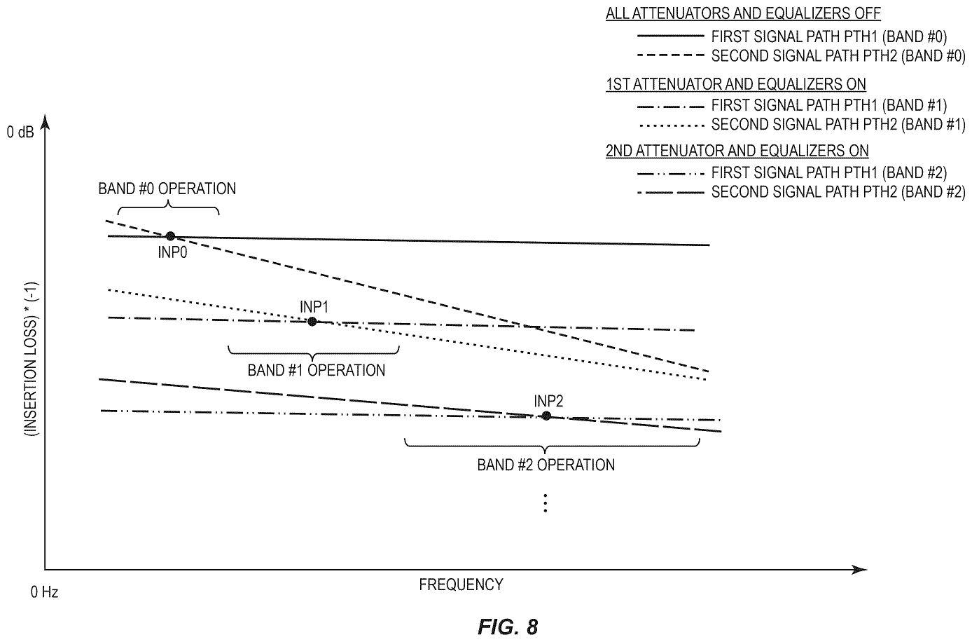

FIG. 8 illustrates insertion loss associated with the different delay states achieved by the reconfigurable TDU 30, as described in the above implementation. Within Band #0 (e.g., the lowest frequency band), the reconfigurable TDU 30 operates similarly to the TDU 10 shown in FIG. 1, where the magnitude error between the first signal path PTH1 (the reference state) and the second signal path PTH2 (the delay state) are within acceptable limits, while the insertion loss of the first and second signal paths PTH1 and PTH2 is minimized to the best achievable level. Typically, the Band #0 is defined, such that an initial intersection point INP0 of the insertion loss trajectories of the first and second signal paths PTH1 and PTH2 might be a center frequency of Band #0 (e.g., if both the insertion loss trajectories of the first and second signal paths PTH1 and PTH2 increase linearly and monotonically). Within Band #1 and Band #2 (e.g., with higher frequencies than Band #0), corresponding attenuators 32 and equalizers 34 are introduced into the first signal path PTH1 and the second signal path PTH2, respectively. In these higher-frequency bands, insertion loss in both the first and second signal paths PTH1 and PTH2 is sacrificed somewhat to maintain the magnitude error between the first and second signal paths PTH1 and PTH2 within acceptable limits.

Herein, the first attenuator 32-1 and the first equalizer 34-1 are designed such that, within Band #1, the insertion loss trajectories of the first and second signal paths PTH1 and PTH2 intersect at a first intersection point INP1, which might be located at a center frequency of Band #1 (e.g., if both the insertion loss trajectories of the first and second signal paths PTH1 and PTH2 increase linearly and monotonically). Additionally, the slope difference between the insertion loss trajectories of the first and second signal paths PTH1 and PTH2 is sufficiently small to ensure that the magnitude error across the entire Band #1 remains within acceptable limits. Similarly, the second attenuator 32-2 and the second equalizer 34-2 are designed such that, within Band #2, the insertion loss trajectories of the first and second signal paths PTH1 and PTH2 intersect at a second intersection point INP2, which might be located at a center frequency of Band #2 (e.g., if both the insertion loss trajectories of the first and second signal paths PTH1 and PTH2 increase linearly and monotonically), and the slope difference between the insertion loss trajectories of the first and second signal paths PTH1 and PTH2 is again small enough to maintain the magnitude error within acceptable limits across the entire Band #2. In different applications, for Band #N operation (where N is a positive integer), more than one attenuator 32 might be switched into the first signal path PTH1, and/or more than one equalizer 34 might be connected to the second signal path PTH2. Additionally, certain one or more attenuators 32 and/or certain one or more equalizers 34 might be reused across multiple frequency bands.

Note that the multiple switchable attenuators 32 and the switchable equalizers 34 enable the added attenuation (insertion loss) applied to the first signal path PTH1 to vary across different frequency bands (e.g., the added attenuation to the first signal path PTH1 for Band #2 is greater than that for Band #1 when Band #2 corresponds with higher frequencies than Band #1). As such, the reconfigurable TDU 30 is capable of achieving acceptable levels of the magnitude error with minimal insertion loss penalties for each frequency band, without incurring a large insertion loss penalty across the entire frequency spectrum, as in the case of the TDU 10 employing the fixed attenuator 18 and the equalizer 20 shown in FIG. 3.

According to aspects disclosed herein, at least one reconfigurable TDU 30 (shown in FIGS. 5A-5B and 7), can be included in communication devices. Examples, without limitation, include a base station, a military application device, a set-top box, an entertainment unit, a navigation device, a fixed location data unit, a mobile location data unit, a global positioning system (GPS) device, a mobile phone, a cellular phone, a smartphone, a session initiation protocol (SIP) phone, a tablet, a phablet, a server, a computer, a portable computer, a mobile computing device, a wearable computing device (e.g., a smartwatch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

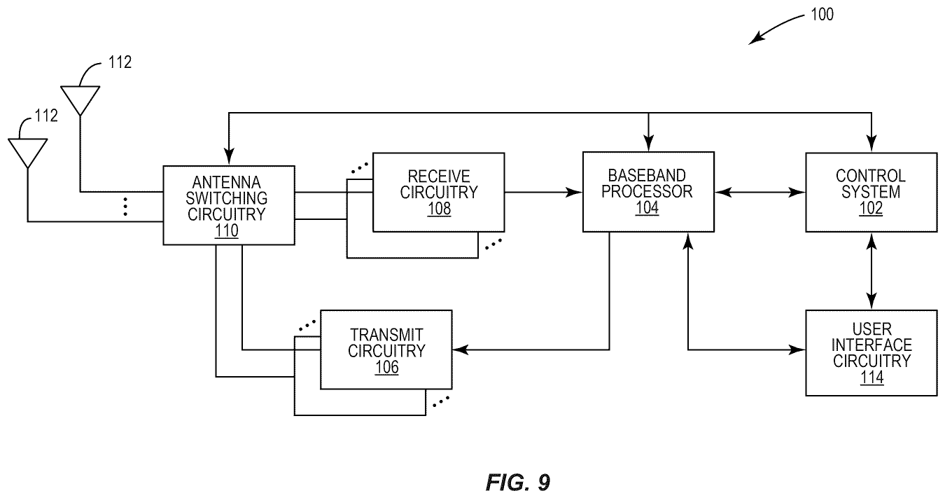

With reference to FIG. 9, the concepts described above may be implemented in various types of communication devices, such as those listed in the previous paragraph. A communication device 100 will generally include a control system 102, a baseband processor 104, transmit circuitry 106, receive circuitry 108, antenna switching circuitry 110, multiple antennas 112, and user interface circuitry 114. In a non-limiting example, the control system 102 can be a field-programmable gate array (FPGA) or an application-specific integrated circuit (ASIC). In this regard, the control system 102 can include at least a microprocessor(s), an embedded memory circuit(s), and a communication bus interface(s). The receive circuitry 108 receives radio frequency signals via the antennas 112 and through the antenna switching circuitry 110 from one or more base stations. A low noise amplifier and a filter of the receive circuitry 108 cooperate to amplify and remove broadband interference from the received signal for processing. Down conversion and digitization circuitry (not shown) will then down convert the filtered, received signal to an intermediate or baseband frequency signal, which is then digitized into one or more digital streams using an analog-to-digital converter(s) (ADC).

The baseband processor 104 processes the digitized received signal to extract the information or data bits conveyed in the received signal. This processing typically comprises demodulation, decoding, and error correction operations, as will be discussed in greater detail below. The baseband processor 104 is generally implemented in one or more digital signal processors (DSPs) and ASICs.

For transmission, the baseband processor 104 receives digitized data, which may represent voice, data, or control information, from the control system 102, which it encodes for transmission. The encoded data is output to the transmit circuitry 106, where a digital-to-analog converter(s) (DAC) converts the digitally encoded data into an analog signal and a modulator modulates the analog signal onto a carrier signal that is at a desired transmit frequency or frequencies. A power amplifier will amplify the modulated carrier signal to a level appropriate for transmission and deliver the modulated carrier signal to the antennas 112 through the antenna switching circuitry 110. The multiple antennas 112 and the replicated transmit and receive circuitries 106, 108 may provide spatial diversity. Modulation and processing details will be understood by those skilled in the art. In some embodiments, at least one reconfigurable TDU 30 can be provided in any one or more of the circuitries in the communication device 100, such as the transmit circuitry 106 and/or the receive circuitry 108.

It is contemplated that any of the foregoing aspects, and/or various separate aspects and features as described herein, may be combined for additional advantage. Any of the various embodiments as disclosed herein may be combined with one or more other disclosed embodiments unless indicated to the contrary herein.

Those skilled in the art will recognize improvements and modifications to the preferred embodiments of the present disclosure. All such improvements and modifications are considered within the scope of the concepts disclosed herein and the claims that follow.

What is claimed is:

1. A reconfigurable True Time-Delay Unit (TDU) operable in multiple frequency bands comprising:
a first signal path;
a second signal path, wherein each of the first signal path and the second signal path extends between an input port and an output port, and the first signal path and the second signal path correspond to different delay states;
at least one attenuator; and
at least one equalizer, wherein:
based on operation in different ones of the multiple frequency bands, the at least one attenuator is selectively switched into or out of the first signal path, while the at least one equalizer is selectively connected to or disconnected from the second signal path; and
for each one of the multiple frequency bands, both insertion loss introduced into the first signal path by the at least one attenuator and an equalization amount applied to the second signal path by the at least one equalizer are different.

2. The reconfigurable TDU of claim 1 wherein the different delay states achieved in the first signal path and the second signal path are implemented using transmission lines.

3. The reconfigurable TDU of claim 2 wherein a total length of transmission lines used in the second signal path is greater than a total length of transmission lines used in the first signal path.

4. The reconfigurable TDU of claim 1 further comprising an input switch and an output switch configured to select between the first signal path and the second signal path from the input port to the output port.

5. The reconfigurable TDU of claim 1 wherein the at least one attenuator is implemented by one or more resistors.

6. The reconfigurable TDU of claim 1 wherein the at least one equalizer is implemented by a resistor and an inductor connected in series and coupled between a certain point of the second signal path and ground.

7. The reconfigurable TDU of claim 1 wherein:
the at least one attenuator comprises a plurality of attenuators; and
each of the plurality of attenuators introduces a different amount of insertion loss to the first signal path.

8. The reconfigurable TDU of claim 1 wherein:
the at least one attenuator comprises a plurality of attenuators;
each of the plurality of attenuators introduces a same amount of insertion loss to the first signal path; and
for each one of the multiple frequency bands, a different number of attenuators from the plurality of attenuators is switched into the first signal path.

9. The reconfigurable TDU of claim 1 wherein:
the at least one equalizer comprises a plurality of equalizers; and
each of the plurality of equalizers introduces a different equalization
amount to the second signal path.

10. The reconfigurable TDU of claim 1 wherein:
the at least one equalizer comprises a plurality of equalizers; and
each of the plurality of equalizers introduces a same equalization amount to the second signal path; and
for each one of the multiple frequency bands, a different number of equalizers from the plurality of equalizers is switched into the second signal path.

11. The reconfigurable TDU of claim 1 wherein:
the at least one attenuator comprises a plurality of attenuators;
the at least one equalizer comprises a plurality of equalizers; and
a certain one or more attenuators of the plurality of attenuators and/or a
certain one or more equalizers of the plurality of equalizers are reused across the multiple frequency bands.

12. The reconfigurable TDU of claim 11 wherein:
each of the plurality of attenuators introduces a different amount of insertion loss to the first signal path; and
each of the plurality of equalizers introduces a different equalization amount to the second signal path.

13. The reconfigurable TDU of claim 11 wherein:
each of the plurality of attenuators introduces a same amount of insertion loss to the first signal path; and
each of the plurality of equalizers introduces a same equalization amount to the second signal path.

14. The reconfigurable TDU of claim 1 wherein:
the at least one attenuator comprises a plurality of attenuators;
the at least one equalizer comprises a plurality of equalizers; and
for a specific one of the multiple frequency bands, the number of
attenuators used for the first signal path from the plurality of attenuators is equal to the number of equalizers used for the second signal path from the plurality of equalizers.

15. The reconfigurable TDU of claim 1 wherein:
the at least one attenuator comprises a plurality of attenuators;
the at least one equalizer comprises a plurality of equalizers; and
each of the plurality of attenuators and each of the plurality of equalizers is used for a specific one of the multiple frequency bands.

16. The reconfigurable TDU of claim 1 wherein for a specific one of the multiple frequency bands. none of the at least one attenuator is switched into the first signal path, and none of the at least one equalizer is connected to the second signal path.

17. The reconfigurable TDU of claim 1 wherein the number of the at least one attenuator and the number of the at least one equalizer are the same.

18. The reconfigurable TDU of claim 1 wherein the number of the at least one attenuator and the number of the at least one equalizer are different.

19. The reconfigurable TDU of claim 1 further comprises:
one or more first switches configured to selectively switch the at least one attenuator into or switch the at least one attenuator out of the first signal path; and
one or more second switches configured to selectively connect the at least one equalizer to or disconnect the at least one equalizer from the second signal path.

20. The reconfigurable TDU of claim 1 wherein the different delay states achieved in the first signal path and the second signal path are implemented using inductors, capacitors, or combinations thereof.

21. A communication device comprising:
receive circuitry;
transmit circuitry; and
antenna switching circuitry, which is configured to transmit radio frequency
signals between antennas and the receive circuitry and/or between the antennas and the transmit circuitry, wherein at least one reconfigurable True Time-Delay Unit (TDU), which comprises a first signal path, a second signal path, at least one attenuator, and at least one equalizer, is included in at least one of the transmit circuitry and the receive circuitry, wherein:
each of the first signal path and the second signal path extends between an input port and an output port, and the first signal path and the second signal path correspond to different delay states;
based on operation in different ones of multiple frequency bands, the at least one attenuator is selectively switched into or out of the first signal path, while the at least one equalizer is selectively connected to or disconnected from the second signal path; and
both insertion loss added to the first signal path by the at least one attenuator and equalization applied to the second signal path by the at least one equalizer are different for each one of the multiple frequency bands.
